(19) United States
(12) Patent Application Publication
(10) Pub. No.: US 2019/0197627 A1
(43) Pub. Date: Jun. 27, 2019

(54) SYSTEM AND METHOD FOR PORTFOLIO OPTIMIZATION

(71) Applicant: LAKE GENEVA INVESTMENT PARTNERS SA, Geneva (CH)

(72) Inventor: Tal SHIR, Geneva (CH)

(21) Appl. No.: 16/226,936

(22) Filed: Dec. 20, 2018

Related U.S. Application Data
(60) Provisional application No. 62/608,793, filed on Dec. 21, 2017.

(51) Int. Cl. G06Q 40/06

(52) U.S. Cl. CPC G06Q 40/06

(57) ABSTRACT

A system and method for portfolio optimization through optimized selection of options. The options are preferably selected according to one of a plurality of parameters, included but not limiting to a parameter related to the option or a parameter related to the underlying security. Non-limiting examples of parameters related to the options include the expiration date of the option, whether the option is a call option or a put option, the type of call option, estimated risk of the option, estimated liquidity of the option and estimated implied volatility of the option. Non-limiting examples of parameters related to the underlying securities include estimated risk of the underlying security, estimated liquidity of the underlying security and estimated volatility of the underlying security.

### FIELD OF THE INVENTION

The present invention relates to a system and method for portfolio optimization, and in particular, to such a system and method for portfolio optimization through optimized selection of options.

### BACKGROUND OF THE INVENTION

Various methods have been described to select components of a portfolio of securities, according to different desired parameters. For example, U.S. Pat. No. 8,140,416 describes another automatic trading algorithm, in this case to seek hidden volume in a market and to trade on that basis.

Options are one example of an investment that can be added to a portfolio, although one that is not mentioned by the patent described above. But adding options to a portfolio brings its own set of complexities. As Avellaneda and Dobi point out (“Modeling Volatility Risk in Equity Options: a Cross-sectional approach”, ICBI Global Derivatives, Amsterdam, 2014), options have complex volatilities. Implied volatility is determined according to the option price while realized volatility is determined according to the historical price of the underlying securities.

### BRIEF SUMMARY OF THE INVENTION

The present invention, in at least some embodiments, overcomes the drawbacks of the background art by providing a system and method for portfolio optimization through optimized selection of options. Without wishing to be limited by a single hypothesis, the resultant selection of options is optimized to have a similar risk profile to a selected securities benchmark, but with a superior Sharpe ratio. As used herein, unless otherwise indicated, the reference to options and to creating a portfolio of options relate to selling options.

In terms of the selected securities benchmark, optionally the underlying securities of the options are determined according to a securities benchmark. Also optionally, a subset of such securities is selected before optimization of the options begins. Alternatively, all securities of the benchmark are considered during selection of the options.

The options are preferably selected according to one of a plurality of parameters, included but not limiting to a parameter related to the option or a parameter related to the underlying security. Non-limiting examples of parameters related to the options include the expiration date for the option, whether the option is a call option or a put option, the type of call option, estimated risk of the option, estimated liquidity of the option and estimated volatility of the option. Non-limiting examples of parameters related to the underlying securities include estimated risk of the underlying security, estimated liquidity of the underlying security and estimated volatility of the underlying security.

The options are also preferably selected according to an overall desired level of risk for the portfolio. Alternatively or additionally, the options are selected according to an overall desired level of liquidity for the portfolio.

The period of time for the option, that is before it expires, is also preferably selected. For example, the period of time could optionally be 1 week, 1 month and so forth. An option with a shorter period of time provides a greater theta, so that selling 12 options sequentially, each with a one month expiry, would have a greater price than selling 1 option for 1 year. The end of such a period of time may also be referred to as the expiration date.

The implied volatility of the options is preferably calculated according to the option prices. Realized volatility can also be used, calculated according to the historical prices of the underlying securities.

Liquidity of the options may optionally be calculated according to the options themselves or according to liquidity of the underlying securities. For the later, liquidity is optionally calculated according to historic liquidity or on calculations of a dynamic liquidity, for example, based on the rate of change daily trading levels and the like. Historic liquidity is preferably determined as the bid/ask spread.

Preferably, the various selected parameters for selecting the plurality of options from a universe of available options include at least risk and liquidity. Preferably also volatility is included.

Next an optimizer optimizes the selection of options from the available options according to at least a desired level of risk and/or a desired level of liquidity. Optionally, one parameter is given more weight than the other, such that greater deference may be given to risk than to liquidity. Preferably, volatility is also included in the optimization.

If an absolute optimized portfolio of options cannot be selected, for example because there are too many underlying securities and/or parameters to consider, then optionally an algorithm such as a clustering algorithm or a genetic algorithm may be used for the selection.

Optionally, the options are put options. Alternatively, the options are call options. If call options, the options are preferably sold while the same amount of the underlying security is bought, for covered call options.

The term “portfolio” as used herein relates to the portfolio of options unless otherwise indicated. The term “overall investment portfolio” is used to indicate a situation in which the portfolio of options is one of a plurality of investments.

In contrast to the background art, the present invention relates to a system and method in which two different types of investment components are analyzed for the purpose of building a portfolio: securities and options on such securities. Without wishing to be limited by a closed list, such an analysis enables the benefits of options to be combined with the benefits of securities, reducing risk while still providing for a beneficial upside to the investment.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Although the present invention is described with regard to a “computing device”, a “computer”, or “mobile device”, it should be noted that optionally any device featuring a data processor and the ability to execute one or more instructions may be described as a computer, including but not limited to any type of personal computer (PC), a server, a distributed server, a virtual server, a cloud computing platform, a cellular telephone, an IP telephone, a smartphone, or a PDA (personal digital assistant). Any two or more of such devices in communication with each other may optionally comprise a “network” or a “computer network”.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the drawings:

FIG. 1 shows an exemplary, non-limiting system for determining a balanced portfolio;

FIG. 2 shows calculation engine in more detail in a non-limiting, exemplary implementation;

FIG. 3 shows a non-limiting, exemplary method for determining a set of components in the portfolio and the price of the corresponding options;

FIG. 4 relates to a non-limiting, exemplary method for selecting the components and selling the options in greater detail;

FIG. 5 relates to a non-limiting, exemplary system, which is similar to that of FIG. 1, with some additional features; and

FIG. 6 relates to a non-limiting, exemplary method for using call options rather than put options.

### DESCRIPTION OF AT LEAST SOME EMBODIMENTS

The present invention, in at least some embodiments, provides a system and method for portfolio optimization through optimized selection of options. Without wishing to be limited by a single hypothesis, the resultant selection of options is optimized to have a similar risk profile to a selected securities benchmark, but with a superior Sharpe ratio. As used herein, unless otherwise indicated, the reference to options and to creating a portfolio of options relate to selling options.

In terms of the selected securities benchmark, optionally the underlying securities of the options are determined according to a securities benchmark. Also optionally, a subset of such securities is selected before optimization of the options begins. Alternatively, all securities of the benchmark are considered during selection of the options. In each such case, the securities available are referred to as the universe of securities.

The selection of options, according to the universe of available securities, is then preferably performed according to a desired level of risk, liquidity, volatility or a combination thereof. Whether the calculations of each of risk, liquidity or volatility are performed with regard to the options themselves, the underlying securities or a combination thereof, preferably these parameters are optimized according to one or more criteria. For example, one or more parameters may be given preferential weight.

Optionally implied volatility of the options is modelled separately. Non-limiting examples of how to model such volatility include but are not limited to the approaches described in Bernales and Guidolin (“Can We Forecast the Implied Volatility Surface Dynamics of Equity Options? Predictability and Economic Value Tests”, 2013, https://papers.ssrn.com/sol3/papers.cfm?abstract_id=2351203) and the above described paper by Avellaneda and Dobi.

According to at least some embodiments of the present invention, there is provided a system and method for using a particular type of option sales in a balanced portfolio to achieve a certain level that is desired of both risk and liquidity. The present invention is described with regard to both “put options” and “call options”, as the system and method described herein are operative for both types of options. A put option is an option contract giving the owner the right, but not the obligation, to sell a specified amount of an underlying security at a specified price within a specified time. This is the opposite of a call option, which gives the holder the right to buy shares. Either type of option may be sold as an investment for a balanced portfolio, as described in greater detail below.

Briefly, regardless of the type of option sold, the balanced portfolio is constructed by selecting a plurality of options to be sold from a particular universe of options, to achieve a desired balance of risk and liquidity. The selected options may differ according to whether put options or call options are sold.

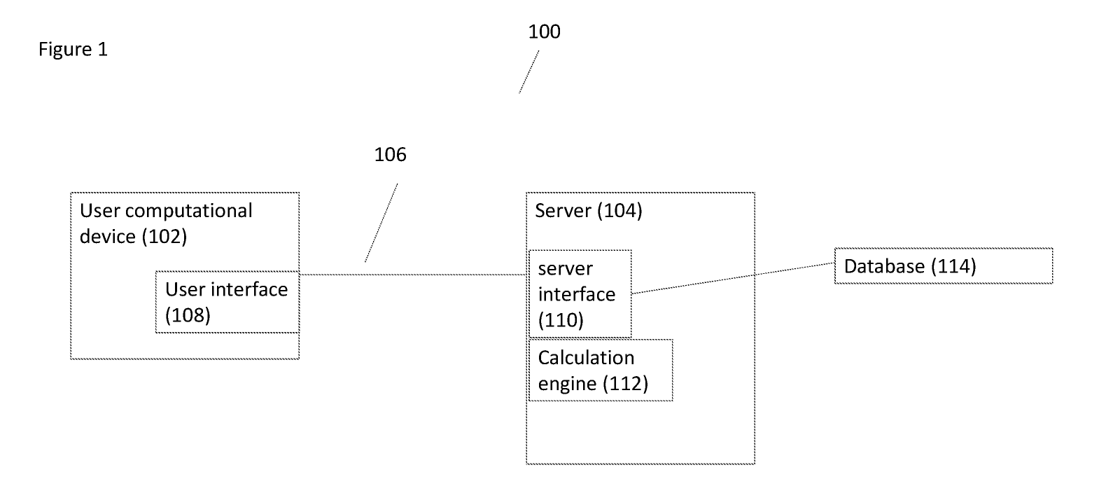

Turning now to the drawings, as shown in FIG. 1, there is a provided an exemplary, non-limiting system 100 for determining a balanced portfolio. System 100 comprises a user computational device 102, which is in communication with a server 104 through a computer network 106, such as the internet, for example. User computational device 102 operates a user interface 108, which might optionally be a stand-alone software, alternatively, which may be a web browser, or the like.

Server 104 operates a server interface 110, which is a software interface for communicating with user interface 108, for example, for receiving commands from user interface 108 and for sending information to be displayed by the display of user computational device 102. Server 104 also features a calculation engine 112 for calculating such parameters as the amount of risk and liquidity in the selected portfolio. Additionally or alternatively, calculation engine 112 may calculate such parameters as the desired length of time for which the option should be sold. For example, for a put option, the length of time would represent the period of time during which the underlying security could be bought at the specified price. For a call option, the length of time would represent the period of time during which the underlying security could be sold at the specified price. For example, the period of time (that is, the expiration date of the option) could optionally be 1 week, 1 month and so forth. An option with a shorter period of time provides a greater theta, so that selling 12 options sequentially, each with a one month expiry, would have a greater price than selling 1 option for 1 year.

Server interface 110 is preferably in communication with a database 114. Database 114 preferably stores such information as historical prices, relative amounts of liquidity, if such information is available, or the parameters for calculating liquidity, if in fact the absolute liquidity is not known. Shorter option periods result in more liquidity.

Through user computational device 102, the user interacts with user interface 108 and sends various commands to server 104. Such commands may request information to determine the total amount of risk in a particular portfolio, and/or to determine the desired option period. Optionally, the user may also select particular components for the portfolio, and/or may adjust the portfolio manually. In that case, calculation engine 112 would need to recalculate the remaining portfolio to maintain balanced parameters.

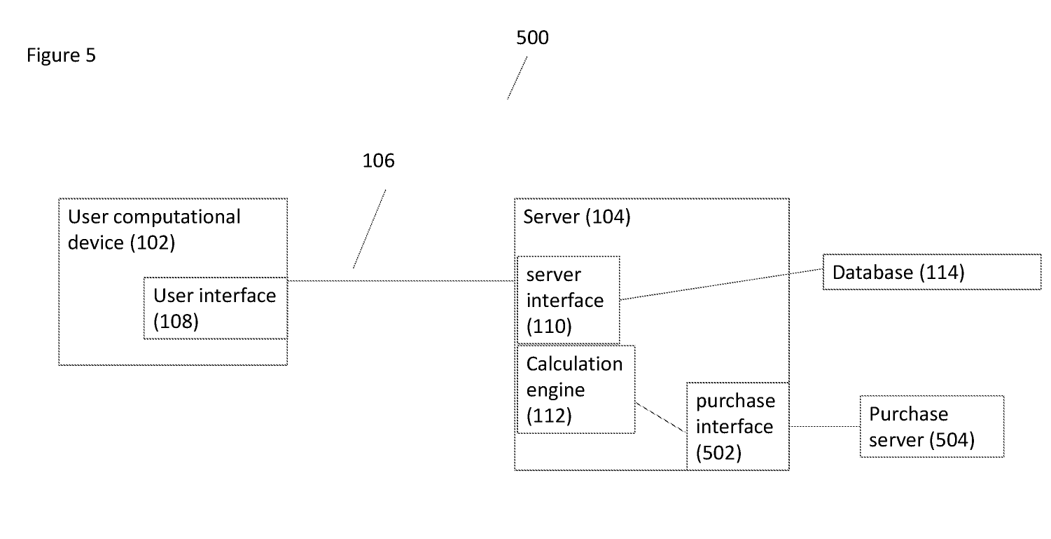

Calculation engine 112 then performs calculations to determine which options, when selected for a particular portfolio from a universe of options, would be best according to the desired parameters. These parameters may comprise the level of risk, the actual liquidity, and the like, for example, by using information taken from database 114. The user may then optionally choose to place an order through user computational device 102 and/or such an order may optionally be placed automatically through server 104. For example, an automatic order may be placed to a market, as shown in FIG. 5.

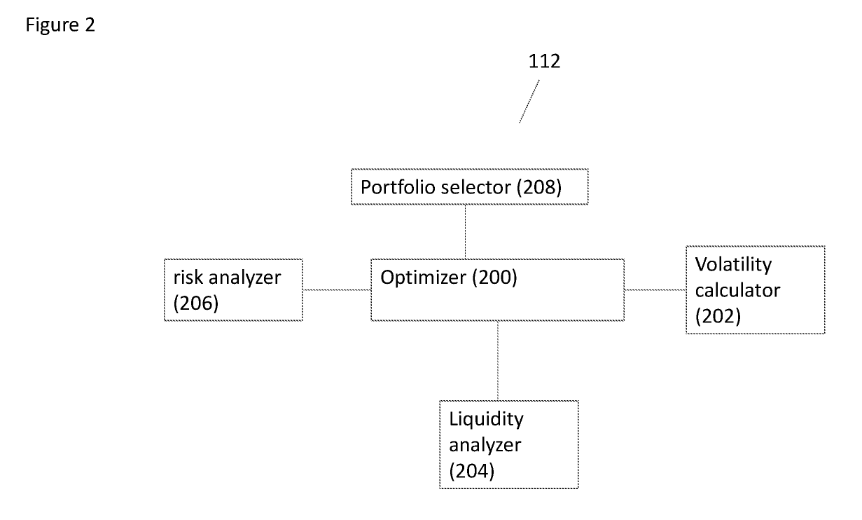

Turning now to FIG. 2, calculation engine 112 is shown in more detail in a non-limiting, exemplary implementation. Tracking engine 112 preferably features an optimizer 200, which receives information of various types, and uses such information to select the best portfolio from the universe of components. Optimizer 200 may also optionally select the best length of time during which the option should be sold, when the option should be rebalanced, such that this period of time is optionally optimized for the amount of risk and/or liquidity.

Optimizer 200 features a volatility calculator 202 for calculating volatility of the selected portfolio. Volatility information can be purchased for example, regarding the particular securities, to determine the implied volatility surface for the underlying securities. A back calculation is performed to determine the realized volatility of the underlying securities. Optionally, if a particular level of volatility is desired, optimizer 200 may consider various combinations of the different portfolio components before selecting a combination which supports the constraint of the desired volatility or volatility range.

Liquidity analyzer 204 analyzes the amount of liquidity in any given combination of portfolio components. For example, to be certain that the overall set of selected components have at least a certain minimum amount of liquidity. Optionally, liquidity analyzer 204 bases this information on historic liquidity or on calculations of a dynamic liquidity, for example, based on the rate of change daily trading levels and the like. Historic liquidity is preferably determined as the bid/ask spread.

Risk analyzer 206 determines the total of risk for a selected set of components, and may optionally also suggest to optimizer 200 in regard to particular components whether perhaps certain components should be included or not included. Optimizer 200 balances all of this information, modeling, in various ways, different sets of portfolio components. In case there are a very large number of components, making an absolute selection by calculating all possibilities would be difficult. Optionally, optimizer 200 relies on any suitable optimization algorithm, including but not limited to any constrained non-linear optimization algorithm, such as Active-Set from Matlab, a clustering or genetic algorithms, or other algorithms, for selecting a set of components from a large set of components, while preferably avoiding problems such as local minima.

Portfolio selector 208 then interacts with optimizer 200 to determine which portfolio components may be selected. Again, optimizer 200 may instruct portfolio selector 208 to keep various options, for example, to increase liquidity, to reduce risk, or to reduce volatility. In cases where certain components are felt to track each other too closely, portfolio selector 208 may be instructed by optimizer 200 to locate portfolio components which do not track each other so closely.

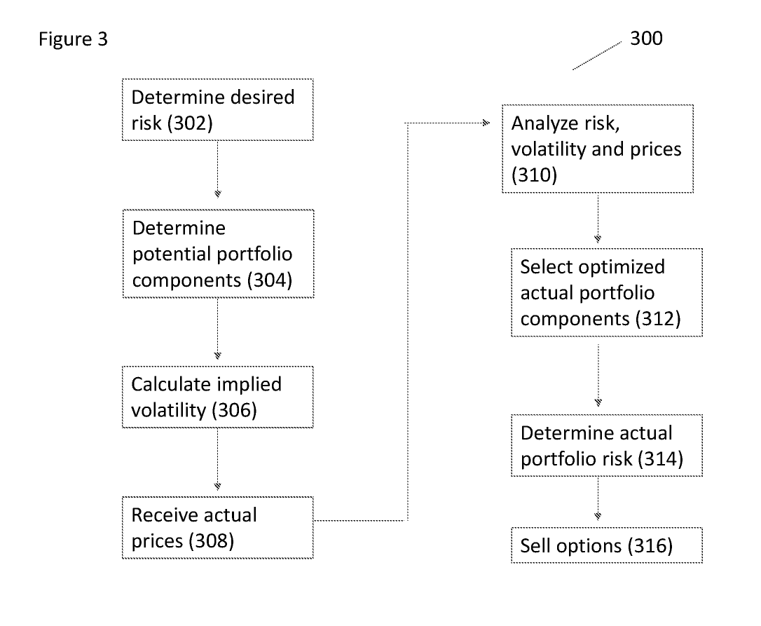

FIG. 3 shows a non-limiting, exemplary method 300 for determining a set of components in the portfolio and the price of the corresponding options. Optionally, put options are sold according the described implementation, although a similar implementation may be made for call options. For selling call options, a covered call is preferably used, so that for each option sold, the underlying security is purchased. This provides the desired balanced of an equity portfolio with reduced risk (although selling the covered call also reduces the upside). This is not required for selling a put option. In stage 302, the desired risk in determined. The desired risk may optionally be determined through instructions from the user or, alternatively, may be determined through calculation, for example, according to a previously constructed portfolio which had a certain level of risk. Also, optionally, the level of desired risk may be determined according to an overall portfolio for a particular customer. In this case, a portfolio of selected options is determined so as not to increase the overall risk of the complete portfolio of the customer.

Next, the potential portfolio components are determined in stage 304. This is the universe of components from which components may be selected for the options. For example, the user may set certain parameters, such as only options or stocks available on the S&P 500 or another stock index, only stocks for which a certain amount of liquidity is available when options are sold, and so forth.

In stage 306, the implied volatility is calculated according to the option prices, as available in the market, as previously described. In stage 308, the actual historical prices are preferably received. Next, in stage 310, the risk, volatility, and prices are preferably analyzed. According to this analysis, the optimized, actual portfolio components are selected in stage 312. Again, if the universe of components is too large to make an absolute analysis of every potential combination, then alternatively the optimized, actual portfolio components are selected to an algorithm, such as a cluster algorithm, a genetic algorithm, and the like, which provide a heuristic measure for a particular selection and which seek to avoid such problems as local minima.

Once the components have been selected, the actual portfolio risk is determined in stage 314. This portfolio risk is relative for the options. For example, such risk is determined according their length, and so optionally it may be determined that in order for the portfolio risk to not be excessive, the options should be a relatively short period of time, such as one week. Alternatively, if a certain minimum level of risk is desired, then the options may be sold for a longer period of time, such as one month or more. In stage 316, the options are sold.

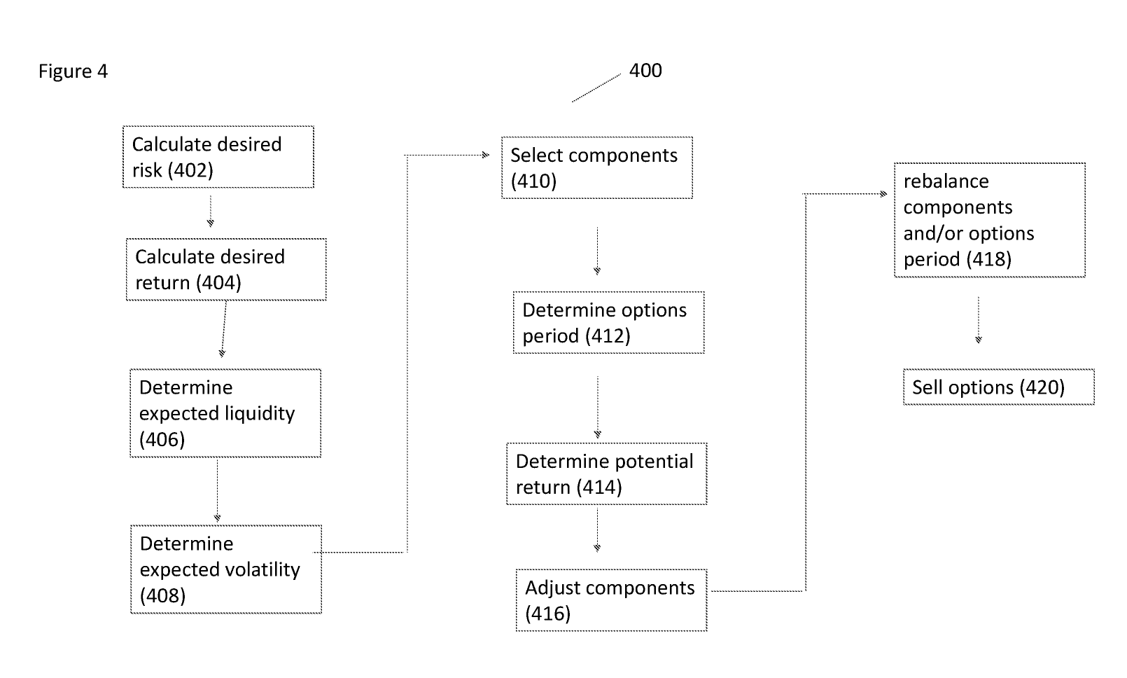

FIG. 4 relates to a non-limiting, exemplary method 400 for selecting the components and selling the options in greater detail. Again, the desired risk is calculated in stage 402, but now so is the desired return in stage 404. It may be necessary to balance the risk and return against each other at later stages.

Next, the expected liquidity is determined in stage 406, for example, from the universe of components, which has been previously determined. The expected volatility is also then calculated in stage 408, again, optionally for the entire universe of components from which selections may be made. In stage 410, the components are selected according to the desired risk, the desired return, the expected volatility, and the expected liquidity, for example, to meet a certain balance between these factors. Optionally, if certain factors are more important than others, then the components are selected to best relate to those more important factors. For example, if liquidity must be at least a certain level or liquidity is considered more important than other parameters, than the components are selected in order to fulfill the desired level of liquidity, potentially at the expense of fulfilling the other parameters.

Next, the options period is determined in stage 412. One reason for determining the options period is, for example, to be able to regulate the level of risk, so as to bring the level of risk closer to the desired risk. The potential return is then calculated in stage 414. In stage 416, the components are optionally adjusted to account for all of these different factors, including desired risk, desired return, expected liquidity, and expected volatility.

In stage 418, the components are rebalanced and/or the options period is redone. This is necessary in order to provide a comprehensive portfolio that fulfills all of the requirements in a balanced manner. In stage 420, the options are sold.

One non-limiting example of a method that can be used for optimization of the selection of the options is as follows. The goal of the method is to find the options portfolio that maximize the “Semi Implied Diversification Ratio”—SIDR. The SIDR is defined as the sum of the weighted implied volatilities of the constituents of the portfolio divided by the portfolio expected realized volatility.

$$S I D R ( w ) = \frac{{w}^{′} s}{\sqrt{{w}^{′} Vw}} = \frac{{w}^{′} s}{σ ( w )}$$

Where w is the weights vector of the portfolio constituents' universe, s is the implied volatilities of the portfolio constituents' universe, V is the covariance matrix and σ(w)is the realized portfolio volatility for a vector w.

The implied option volatility is optionally calculated by inversing Black-Scholes formula. For this calculation to be performed, the price of the option, the expiration date, dividend yield, interest rate, strike price and underlying price of the security are input into the inverse formula, to obtain the volatility. The price for the options is the market price (that is, the price offered by the market for the particular option and expiration date).

The covariance matrix is preferably calculated according to the standard calculation, optionally plus one or more weights. For example the matrix may be exponentially weighted for a more recent time period than for data from a period that is farther back in the past.

Weights for portfolio are determined according to how much of the portfolio is taken up by each option. The maximum amount of any given option or group of options may be limited.

In this implementation, the optimizer seeks to create a portfolio with the biggest SIDR ratio, optionally as constrained by other factors (such as liquidity, volatility and/or overall risk levels).

The method provides exposure to more than just price with implied volatility, thereby bringing in other risk factors, which may be adjusted according to the desired weight of the above factors.

FIG. 5 relates to a non-limiting, exemplary system 500, which is similar to that of FIG. 1, with some additional features. Optionally, a command is given to purchase interface 502 to automatically execute the selling and/or buying commands, which are then transmitted to purchase server 504, which may be, for example, on a particular stock exchange or other market, or a plurality of such exchanges. The connection to purchase server 504 may optionally be described as a market interface.

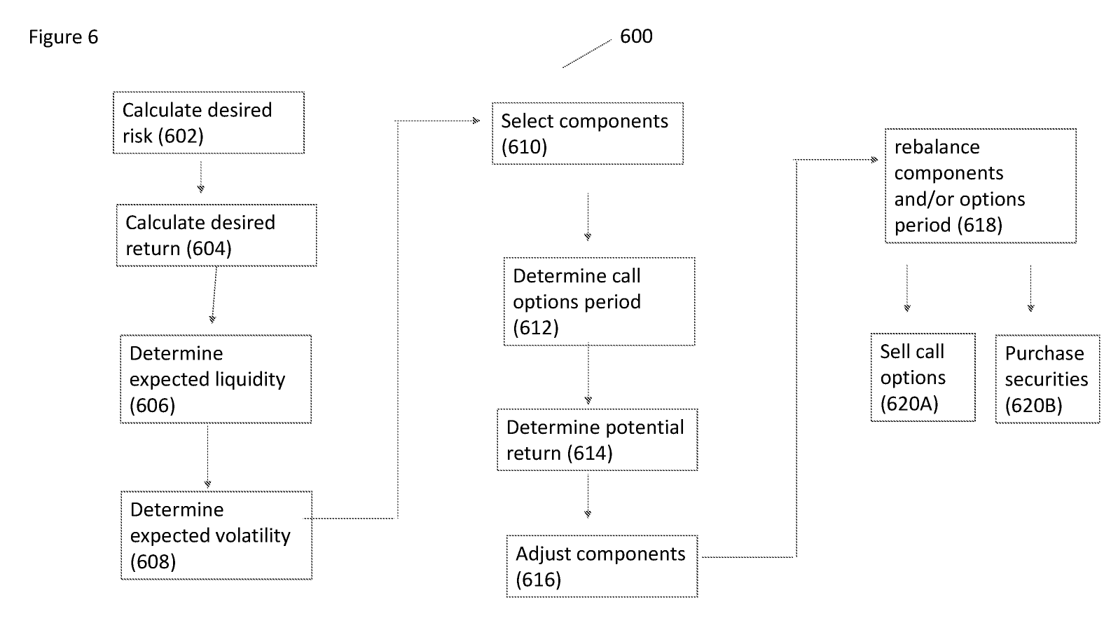

FIG. 6 relates to a non-limiting, exemplary method 600, in relation to using call options rather than put options. Calculated risk is calculated in stage 602. Desired return is calculated in stage 604. Expected liquidity is determined in stage 606, and expected volatility is determined in stage 608. Because of the slightly different nature of what is being purchased, it is possible that these factors will be affected by this.

In stage 610, the components are selected and then the period is determined in stage 612. Again, because of the different nature of what is being sold, it is possible that this period will need to be adjusted. Of course, the potential return in stage 604 may differ, and hence the need to adjust components in stage 606 may differ. Rebalancing of the components and of the period is also expected to be different in stage 618. The options are then sold in stage 620A, while the underlying securities are purchased in stage 620B, for covered call options. These two stages are preferably performed in parallel.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A system for portfolio optimization through optimized selection of a plurality of options related to a plurality of underlying securities, selected according to a parameter related to the option and/or a parameter related to the underlying security.

2. The system of claim 1, further comprising a user computational device, comprising a user interface for providing information regarding one or more parameters and a display for displaying a result of the portfolio optimization; and a server in communication with the user computational device, said server comprising an optimizer for optimizing selection of the options according to said parameter.

3. The system of claim 2, further comprising a market interface, operated by said server, for purchasing the selected options, wherein said market interface is in connection with at least one exchange for purchasing the selected options.

4. The system of claim 3, wherein said market interface relates to a plurality of exchanges.

5. The system of claim 4, further comprising a database for storing historical information regarding the underlying securities.

6. The system of claim 1, wherein parameters related to the options include one or more of the expiration date of the option, whether the option is a call option or a put option, the type of call option, estimated risk of the option, estimated liquidity of the option and estimated volatility of the option.

7. The system of claim 1, wherein parameters related to the underlying securities include one or more of estimated risk of the underlying security, estimated liquidity of the underlying security and estimated volatility of the underlying security.

8. The system of claim 7, wherein said optimizer optimizes selection of the options according to an overall desired level of risk for the portfolio.

9. The system of claim 8, wherein said optimizer optimizes selection of the options according to an overall desired level of liquidity for the portfolio.

10. The system of claim 9, wherein the expiration date of the option is selected.

11. The system of claim 10, wherein the expiration date of the option is selected from the group consisting of 1 week, 1 month or any integral value in between.

12. The system of claim 8, wherein said optimizer optimizes selection of the options according to an overall desired level of volatility for the portfolio.

13. The system of claim 12, wherein the volatility of the options is calculated according to the volatility of the underlying securities, according to historical volatility information for these securities.

14. The system of claim 13, wherein the volatility is calculated as the volatility surface for these securities.

15. The system of claim 12, wherein the implied volatility of the options is calculated according to option price information.

16. The system of claim 15, wherein liquidity of the options is calculated according to the options themselves or according to liquidity of the underlying securities.

17. The system of claim 16, wherein liquidity of the underlying securities is calculated according to historic liquidity or on calculations of a dynamic liquidity.

18. The system of claim 17, wherein the optimizer selects the plurality of options from a universe of available options include at least risk and liquidity.

19. The system of claim 18, wherein greater deference is given to one of risk or liquidity for optimization.

20. The system of claim 19, wherein optimization is performed according to a clustering algorithm or a genetic algorithm.

21. The system of claim 1, wherein the options are put options.

22. The system of claim 1, wherein the options are covered call options.

23. A method for portfolio optimization through optimized selection of a plurality of options related to a plurality of underlying securities, wherein the method is operated by a computational device according to the system of any of the above claims, comprising selecting the options according to a parameter related to the option and/or a parameter related to the underlying security.
